(19) United States
(12) Patent Application Publication
(10) Pub. No.: US 2019/0393755 A1
(43) Pub. Date: Dec. 26, 2019

(54) VEHICLE DRIVE APPARATUS

(71) Applicant: Honda Motor Co., Ltd., Tokyo (JP)

(72) Inventor: Andrii Pydin, Wako-shi (JP)

(21) Appl. No.: 16/443,132

(22) Filed: Jun. 17, 2019

(30) Foreign Application Priority Data
Jun. 25, 2018 (JP) 2018-119937

(51) Int. Cl. H02K 7/116; B62K 5/10; H02K 7/06

(52) U.S. Cl. CPC H02K 7/1166; B60N 2/2362; H02K 7/06; B62K 5/10

(57) ABSTRACT

A vehicle drive apparatus, including an electric motor including a rotor rotating about a first axial line in a vertical direction and a stator disposed around the rotor, a first rotating shaft rotating integrally with the rotor and including a first gear at an end portion thereof, a pair of left and right second rotating shafts extended along second axial lines parallel to the first axial line and including second gears at end portions thereof so as to mesh with the first gear and worm gears rotating about the pair of left and right second axial lines, a pair of left and right worm wheels rotatable about a third axial line in a left-right direction and provided so as to mesh with the worm gears, and a pair of left and right drive shafts to which torques from the worm wheels are input.

### CROSS-REFERENCE TO RELATED APPLICATION

This application is based upon and claims the benefit of priority from Japanese Patent Application No. 2018-119937 filed on Jun. 25, 2018, the content of which is incorporated herein by reference.

### BACKGROUND OF THE INVENTION

### Field of the Invention

This invention relates to a vehicle drive apparatus for traveling a vehicle by a power of an electric motor.

### Description of the Related Art

Conventionally, there is a known vehicle drive apparatus of this type, in which an electric motor is installed under a vehicle seat in a state with an axis of rotation of the motor oriented in vehicle height direction and torque of the motor is transmitted to a horizontally extending shaft through a pair of bevel gears. Such an apparatus is described in Japanese Unexamined Patent Publication No. 2012-029369 (JP2012-029369A), for example. In the apparatus described in JP2012-029369A, a bevel gear is provided on an upper end portion of a shaft fitted on a center part of a rotor of the motor, so that a bevel gear provided on an end portion of the horizontally extending shaft meshes therewith.

However, since the apparatus described in JP2012-029369A is configured to transmit torque of the motor to the horizontally extending shaft through the pair of bevel gears, it is necessary to increase diameters of the bevel gears in order to transmit large torque to the horizontally extending shaft. As a result, the vehicle drive apparatus becomes vertically large, and it is difficult to install the vehicle drive apparatus capable of transmitting large torque in a vehicle's limited available space in the vertical direction.

### SUMMARY OF THE INVENTION

An aspect of the present invention is a vehicle drive apparatus, including: an electric motor including a rotor rotating about a first axial line in a vertical direction and a stator disposed around the rotor; a first rotating shaft extended along the first axial line to rotate integrally with the rotor and including a first gear at an end portion thereof; a pair of left and right second rotating shafts extended along a pair of left and right second axial lines parallel to the first axial line in a state separate from each other in a left-right direction, and including second gears at end portions thereof so as to mesh with the first gear respectively and worm gears rotating about the pair of left and right second axial lines; a pair of left and right worm wheels rotatable about a third axial line in the left-right direction and provided so as to mesh with the worm gears, respectively; and a pair of left and right drive shafts to which torques from the pair of left and right worm wheels are input, respectively.

### BRIEF DESCRIPTION OF THE DRAWINGS

The objects, features, and advantages of the present invention will become clearer from the following description of embodiments in relation to the attached drawings, in which:

FIG. 1 is a perspective view showing a main part of a vehicle drive apparatus according to an embodiment of the present invention;

FIG. 2 is a skeleton diagram of the vehicle drive unit of FIG. 1;

FIG. 3 is a diagram showing a relationship between a target speed difference between left and right drive shafts of FIG. 1 and a target speed of an electric motor used as a power distributor;

FIG. 4A is a diagram showing a torque transmission path during a straight travel in the vehicle drive apparatus according to the embodiment of the present invention;

FIG. 4B is a diagram showing a torque transmission path during a turn travel in the vehicle drive apparatus according to the embodiment of the present invention;

FIG. 5A is an aliment chart showing an example of an operation during a straight travel in the vehicle drive apparatus according to the embodiment of the present invention; and

FIG. 5B is an aliment chart showing an example of an operation during a turn travel in the vehicle drive apparatus according to the embodiment of the present invention.

### DETAILED DESCRIPTION OF THE INVENTION

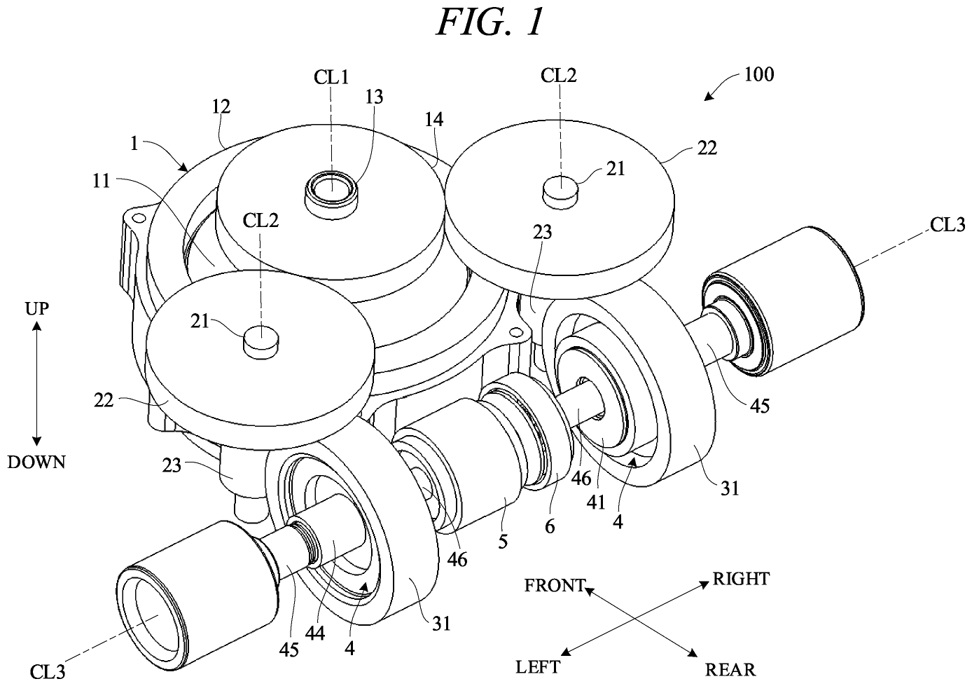

An embodiment of the present invention will be described with reference to FIGS. 1 to 5B. FIG. 1 is a perspective view showing a main part configuration of a vehicle drive apparatus 100 according to the embodiment of the present invention. For example, if the vehicle is formed as a front-wheel drive vehicle, the vehicle drive apparatus 100 is disposed between the left and right front wheels. For example, if the vehicle is formed as a rear-wheel drive vehicle, the vehicle drive apparatus 100 is disposed between the left and right rear wheels. The configuration of the components of the vehicle drive apparatus 100 will be described below using the front-rear direction (vehicle length direction), the up-down direction (vehicle height direction), and the left-right direction (vehicle width direction) of the vehicle having the vehicle drive apparatus 100 mounted thereon. The front-rear direction, the up-down direction, and the left-right direction are defined as shown in FIG. 1.

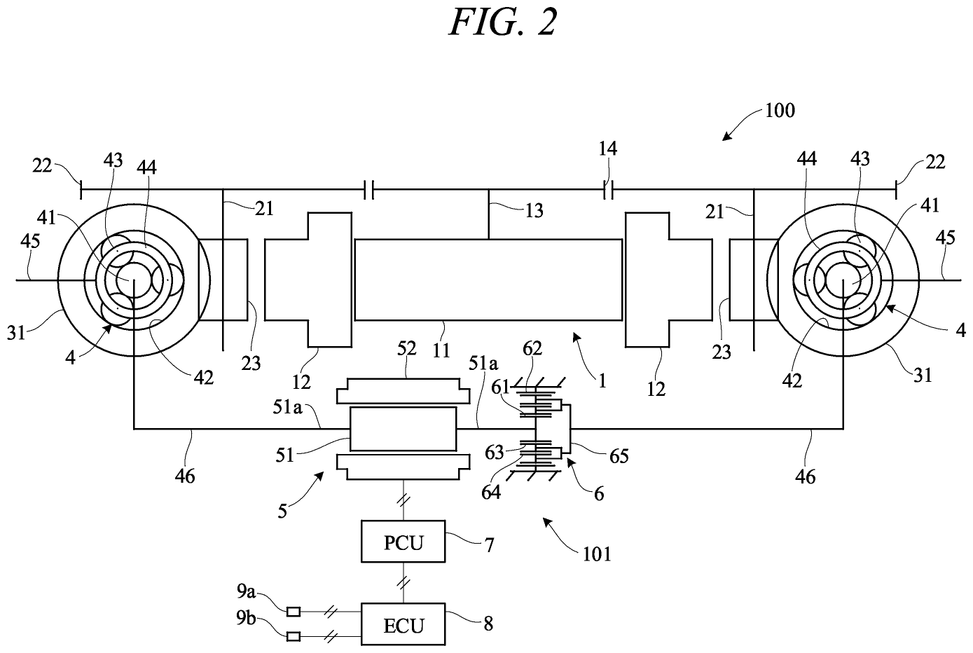

FIG. 2 is a skeleton diagram of the vehicle drive apparatus 100. As shown in FIGS. 1 and 2, the vehicle drive apparatus 100 includes an electric motor 1, which is an example of a rotating armature and serves as a drive source, and outputs a travel drive torque produced by the electric motor 1 to the drive wheels (front wheels or rear wheels). For this reason, the vehicle drive apparatus 100 is mounted on a vehicle including the electric motor 1 as a travel drive source, such as an electric vehicle or hybrid vehicle. The electric motor 1 can also be used as an electric generator.

The electric motor 1 includes a rotor 11 that rotates around an axis CL1 extending in the up-down direction and a stator 12 disposed around the rotor 11. The electric motor 1 is, for example, an magnet-embedded synchronous motor, and multiple permanent magnets are circumferentially embedded in the rotor 11 (rotor core). The electric motor 1 may be a synchronous reluctance motor, switched reluctance motor, or the like, which includes no magnet.

The stator 12 includes an approximately cylindrical stator core disposed around the axis CL1 and radially spaced from the outer circumferential surface of the rotor 11 (rotor core) by a predetermined length. Multiple slots that are oriented radially outward are circumferentially provided on the inner circumferential surface of the stator core. A winding (coil) is disposed in each slot by concentrated winding or distributed winding. By passing a three-phase alternating current through the windings, a rotating magnetic field occurs and rotates the rotor 11.

The rotor 11 contains a first rotating shaft 13 that extends along the axis CL1. The first rotating shaft 13 is coupled to the rotor 11, for example, by spline coupling and rotates integrally with the rotor 11. The upper end of the first rotating shaft 13 protrudes from the upper end surface of the rotor 11 and is provided with a first gear 14 having a smaller diameter than the rotor 11. The first gear 14 is coupled to the first rotating shaft 13, for example, by spline coupling and rotates integrally with the first rotating shaft 13. The first gear 14 is formed in, for example, a spur gear or helical gear.

A pair of left and right second rotating shafts 21 are disposed on sides (rear-right and rear-left sides) of the electric motor 1 so as to be rotatable around axes CL2 extending in the up-down direction. The upper ends of the pair of second rotating shafts 21 are provided with second gears 22. The second gears 22 are coupled to the second rotating shafts 21, for example, by spline coupling and rotate integrally with the second rotating shafts 21. The left and right second gears 22 have the same configuration and consist of spur gears or helical gears. The first gear 14 and the pair of second gears are located at the same height and are engaged with each other above the rotor 11 (on the inner diameter side of the inner circumferential surface of the stator 12).

Worms 23 forming worm gears are provided on the left and right second rotating shafts 21 so as to be located below the second gears 22 and on sides of the electric motor 1. The left and right worms 23 have the same configuration and are threaded gears having helical and continuous teeth formed thereon. The worms 23 are coupled to the second rotating shafts 21, for example, by spline coupling and rotate integrally with the second rotating shafts 21. The worms 23 may be formed by machining the outer circumferential surfaces of the second rotating shafts 21.

A pair of left and right worm wheels (helical gears) 31 are coaxially disposed in rear of the left and right worms 23 so as to be rotatable around an axis CL3 extending in the left-right direction. The left and right worms 23 are engaged with the left and right worm wheels 31, respectively. The left and right worm wheels 31 have the same configuration and are approximately cylindrical as a whole. The worm wheels 31 are located below the second gears 22. The axis CL3 is located in a position corresponding to the central portion in the height direction of the electric motor 1, and the outer diameter of the worm wheels 31 is approximately equal to the height of the electric motor 1.

In the left and right worm wheels 31, a pair of single-pinion left and right first planetary gear mechanisms 4 having the same configuration are housed. The left and right first planetary gear mechanisms 4 each include a sun gear 41, a ring gear 42 surrounding the sun gear 41, multiple (e.g., three) pinions 43 that are circumferentially disposed and engaged with the sun gear 41 and ring gear 42, and a carrier 44 that rotatably supports the pinions 43. The sun gear 41, ring gear 42, and carrier 44 rotate around the axis CL3. The ring gear 42 is fixed to or formed on the inner circumferential surface of the worm wheel 31 and rotates integrally with the worm wheel 31.

The left and right carriers 44 extend outward in the left-right direction along the axis CL3. More specifically, the carrier 44 of the left first planetary gear mechanism 4 extends leftward, and the carrier 44 of the right first planetary gear mechanism 4 extends rightward. A pair of left and right drive shafts 45 are coupled to ends in the left-right direction of the carriers 44 by spline coupling or the like, and the carriers 44 and drive shafts 45 rotate integrally. Wheels (drive wheels; not shown) are coupled to ends of the drive shafts 45, and the drive shafts 45 and the wheels rotate integrally.

A pair of left and right rotating shafts 46 extending inward in the left-right direction along the axis CL3 are coupled to the left and right sun gears 41 by spline coupling or the like, and the left and right sun gears 41 and the left and right rotating shafts 46 rotate integrally. An electric motor 5 and a double-pinion second planetary gear mechanism 6 are serially interposed between the left and right rotating shafts 46. Hereafter, the electric motor 1 may be referred to as a first electric motor, and the electric motor 5 as a second electric motor.

The electric motor 5 includes a rotor 51 that rotates around the axis CL3 and a stator 52 disposed around the rotor 51. The electric motor 5 is, for example, a magnet-embedded synchronous motor, and multiple permanent magnets are circumferentially embedded in the rotor 51 (rotor core). The electric motor 5 may be a synchronous reluctance motor, switched reluctance motor, or the like, which include no magnet.

The stator 52 includes an approximately cylindrical stator core disposed around the axis CL3 and radially spaced from the outer circumferential surface of the rotor 51 (rotor core) by a predetermined length. Multiple slots that are oriented radially outward are circumferentially provided on the inner circumferential surface of the stator core. A winding (coil) is disposed in each slot by concentrated winding or distributed winding. By passing a three-phase alternating current through the windings, a rotating magnetic field occurs and rotates the rotor 51. A rotating shaft 51a of the rotor 51 of the electric motor 5 is coupled to the right end of the left rotating shaft 46 by spline coupling or the like so that the rotating shaft 46 rotates integrally with the rotor 51.

The second planetary gear mechanism 6 includes a sun gear 61, a ring gear 62 surrounding the sun gear 61, multiple first pinion gears 63 and multiple second pinions 64 circumferentially disposed between the sun gear 61 and ring gear 62, engaged with the sun gear 61 and ring gear 62, and engaged with each other, and a carrier 65 that rotatably supports the first pinion gears 63 and second pinions 64. The sun gear 61 and carrier 65 rotate around the axis CL3. The ring gear 62 is unrotatably fixed to a case or the like. The tooth number of the ring gear 62 is twice the tooth number of the sun gear 61.

The carrier 65 extends rightward along the axis CL3. The left end of the right rotating shaft 46 is coupled to the right end of the carrier 65 by spline coupling or the like so that the carrier 65 rotates integrally with the rotating shaft 46. The right end of the rotating shaft 51a of the rotor 51 is coupled to the sun gear 61 by spline coupling or the like so that the rotor 51 rotates integrally with the sun gear 61.

The electric motor 5 is controlled in accordance with a command from a controller (ECU) 8 through a power control unit (PCU) 7. Specifically, the power control unit 7 includes an inverter, and when the inverter is controlled in accordance with a command from the controller 8, the rotation (rotation speed, rotation direction) of the electric motor 5 is controlled.

More specifically, the controller 8 includes an arithmetic processing unit having CPU, ROM, RAM, and other peripheral circuits. The controller (ECU) 8 receives signals from a vehicle speed sensor 9a that detects the vehicle speed and a steering angle sensor 9 that detects the steering angle of the steering wheel, and the electric motor 5 is controlled in accordance with these signals. The electric motor 1 is also controlled in accordance with a command from the controller 8 through the power control unit (PCU) 7. For example, the electric motor 1 is controlled in accordance with the manipulated variable or the like of an accelerator pedal. The electric motor 5, second planetary gear mechanism 6, controller (ECU) 8, and the like form a speed difference absorbing unit 101 that absorbs the speed difference between the left and right drive shafts 45 during a turn of the vehicle.

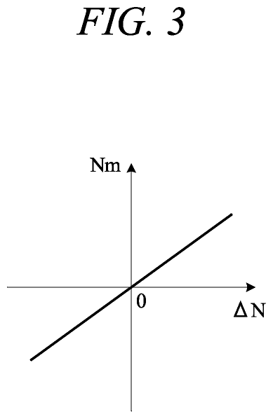

FIG. 3 is a diagram showing the relationship between the target speed difference ΔN between the left and right drive wheels, i.e., target rotational speed difference between rotational speed of the left drive wheel and rotational speed of the right drive wheel, and the target speed (target rotational speed) Nm of the electric motor 5, previously stored in the memory of the controller 8. Characteristics in FIG. 3 are proportional characteristics passing 0. The target speed difference ΔN is 0 during a straight travel of the vehicle; it is, for example, positive during a left turn of the vehicle; and it is, for example, negative during a right turn of the vehicle. The target speed Nm (absolute value) becomes greater as the target speed difference ΔN (absolute value) becomes greater.

The controller 8 (CPU) calculates the target speed difference ΔN on the basis of the signals from the vehicle speed sensor 9a and steering angle sensor 9b, as well as calculates the target speed Nm corresponding to the target speed difference ΔN in accordance with the characteristics in FIG. 3. The controller 8 then outputs a control signal to the power control unit 7 so that the rotational speed of the electric motor 5 becomes the target speed Nm.

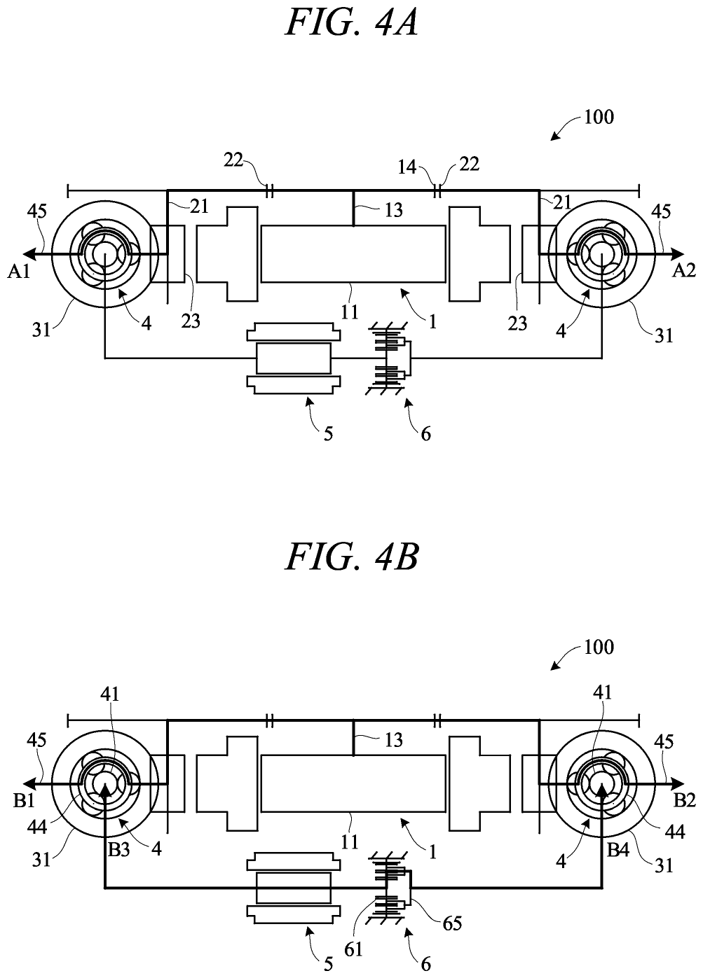

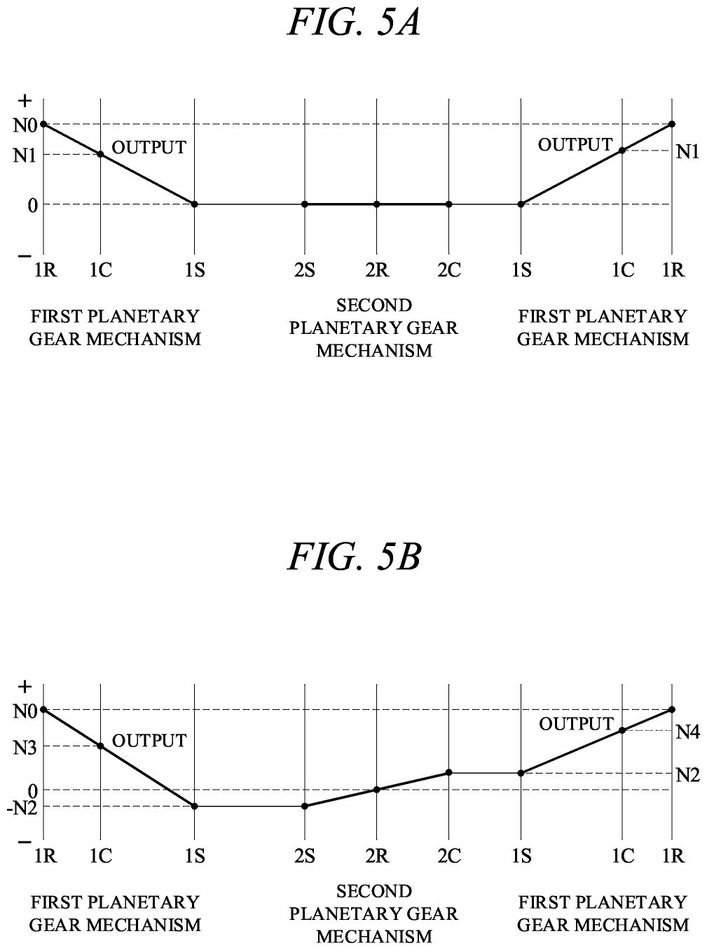

A main operation of the vehicle drive apparatus 100 thus configured will be described. FIGS. 4A and 4B are diagrams showing torque transmission paths during a straight travel and during a turn travel, respectively. FIGS. 5A and 5B are alignment charts showing examples of operations of the vehicle drive apparatus 100 during a straight travel and during a turn travel, respectively. In FIGS. 5A and 5B, the sun gears 41, ring gears 42 and carriers 44 of the left and right first planetary gear mechanisms 4 are represented by 1S, 1R, and 1C, respectively, and the sun gear 61, ring gear 62, and carrier 65 of the second planetary gear mechanism 6 are represented by 2S, 2R, and 2C, respectively. The rotation direction when the vehicle moves forward is defined as the forward direction, and the forward direction is represented by “+”.

As shown by arrows A1, A2 in FIG. 4A, during a straight travel, the torque of the electric motor 1 is transmitted to the left and right pair of worm wheels 31 through the first rotating shaft 13 that rotates integrally with the rotor 11, the first gear 14, the pair of left and right second gears 22, the pair of left and right second rotating shafts 21, and the pair of left and right worms 23. The elements from the left second gear 22 to the left worm wheel 31 and those from the right second gear 22 to the right worm wheel 31 are the same and therefore the left and right worm wheels 31 rotate at the same speed. The torque of the left and right worm wheels 31 is transmitted to the pair of left and right drive shafts 45 through the pair of left and right first planetary gear mechanisms 4, causing the vehicle to travel.

In this case, the rotation of the electric motor 5 is stopped. Thus, as shown in FIG. 5A, both of the sun gears 41 (1S) of the left and right first planetary gear mechanisms 4 are stopped, and the carriers 44 (1C) of the left and right first planetary gear mechanisms 4 are rotated at the same speed N1. As a result, the vehicle travels straight.

As shown by arrows B1 and B2 in FIG. 4B, also during a turn travel, the torque of the electric motor 1 is transmitted to the pair of left and right worm wheels 31, as in during a straight travel. Also, the torque of the left and right worm wheels 31 is transmitted to the left and right drive shafts 45 through the first planetary gear mechanisms 4. At this time, as shown in FIG. 5B, the electric motor 5 rotates at the target speed Nm (e.g., −N2) determined by the vehicle speed and steering angle. Thus, while rotational speed of the sun gear 61 (2S) of the second planetary gear mechanism 6 is −N2, rotational speed of the carrier 65 (2C) is +N2.

More specifically, as shown by arrows B3 and B4 in FIG. 4B, the torque of the electric motor 5 is inputted to the sun gear 41 of the left first planetary gear mechanism 4 without change, while the torque of the electric motor 5 is changed by the second planetary gear mechanism 6 and then inputted to the sun gear 41 of the right first planetary gear mechanism 4. Thus, a difference in rotational speed occurs between the left and right sun gears 41. As a result, as shown in FIG. 5B, rotational speed N3 of the carrier 44 (1C) of the left first planetary gear mechanism 4 becomes smaller than rotational speed N4 of the carrier 44 (1C) of the right first planetary gear mechanism 4.

As seen above, in the present embodiment, both during the straight travel and during the turn travel, the torque of the electric motor 1 is transmitted to the pair of left and right worm wheels 31 through the pair of left and right worms 23. Thus, a large torque can be easily transmitted to the left and right drive shafts 45. For example, when transmitting a larger torque of the electric motor 1 to a single worm wheel through a single worm gear, the diameter of the worm wheel has to be increased, and the diameter-increased worm wheel would be difficult to dispose below the second gear 22. On the other hand, in the present embodiment, the torque of the electric motor 1 is distributed to the pair of left and right worm wheels 31. This eliminates the need to increase the diameter of the worm wheels 31, allowing the worm wheels 31 to be easily disposed below the second gears 22. As a result, upsizing of the vehicle drive apparatus 100 in the height direction can be prevented.

According to the embodiment, the following operations and effects can be achieved.

(1) The vehicle drive apparatus 100 includes the electric motor 1 including the rotor 11 that rotates around the axis (first axis) CL1 extending in the up-down direction and the stator 12 disposed around the rotor 11, the first rotating shaft 13 that extends along the axis CL1, has the first gear 14 on the end thereof, and is disposed so as to be rotatable integrally with the rotor 11, the pair of left and right second rotating shafts 21 that are disposed in a standing manner along the pair of left and right axes (second axes) CL2 parallel with the axis CL1 so as to be spaced from each other in the left-right direction, have the second gears 22 engaged with the first gear 14 on the ends thereof, and are integrally provided with the worms 23 that rotate around the axes CL2, the pair of left and right worm wheels 31 that are engaged with the worms 23 of the pair of left and right second rotating shafts 21 and are disposed so as to be rotatable around the axis (third axis) CL3 extending in the left-right direction, and the pair of left and right drive shafts 45 that receive the torque from the pair of left and right worm wheels 31 (FIGS. 1 and 2).

This configuration prevents upsizing of the vehicle drive apparatus 100 in the height direction and is able to transmit the torque of the electric motor 1 that rotates around the axis CL1 extending in the up-down direction, to the worm wheels 31 that rotate around the axis CL3 extending in the left-right direction while obtaining a sufficient reduction ratio and thus to cause the vehicle to travel with a large torque. Thus, the vehicle drive apparatus 100 can be easily disposed in a predetermined height-limited space in the vehicle. In other words, since the torque of the electric motor 1 is transmitted to the worm wheels 31 not through a bevel gear but through the second gears 22 disposed on the ends of the second rotating shafts 21 and the worms 23 provided at the second rotating shafts 21, the diameter of the second gears 22 can be increased without expanding the vehicle drive apparatus 100 in the height direction, allowing for easy transmission of a large torque to the drive shafts 45. Also, the torque of the electric motor 1 is distributed to the pair of left and right worm wheels 31 through the pair of left and right worms 23. Thus, a large torque can be easily transmitted to the drive shafts 45 without enlarging the diameter of the worm wheels 31.

(2) The vehicle drive apparatus 100 further includes the pair of left and right first planetary gear mechanisms 4 that are housed in the pair of left and right worm wheels 31 and transmit power from the pair of left and right worm wheels 31 to the pair of left and right drive shafts 45, and the speed difference absorbing unit 101 that absorbs the speed difference between the pair of left and right drive shafts 45 during a turn travel of the vehicle (FIG. 2). Thus, the vehicle drive apparatus 100 is able to change the speed of the rotation of the worm wheels 31 and to transmit the resulting rotation to the drive shafts 45, making the turn travel favorable.

(3) The pair of left and right first planetary gear mechanisms 4 include the pair of left and right ring gears 42 connected to the pair of left and right worm wheels 31, the pair of left and right carriers 44 connected to the pair of left and right drive shafts 45, and the pair of left and right sun gears 41 (FIG. 2). The speed difference absorbing unit 101 includes the electric motor 5 and double-pinion second planetary gear mechanism 6 serially interposed between the pair of left and right sun gears 41 and the controller 8 that controls the electric motor 5. Thus, the speed difference absorbing unit 101 is able to make a difference in rotational speed between the left and right drive shafts 45 in response to the drive of the electric motor 5. Also, by using the double-pinion second planetary gear mechanism 6, the entire apparatus can be downsized compared to when using a differential mechanism including a pair of left and right side gears, a pair of pinion gears, or the like.

(4) The second planetary gear mechanism 6 includes the ring gear 62 disposed in non-rotatable manner, the carrier 65 connected to one (e.g., right sun gear 41) of the pair of left and right sun gears 41, and the sun gear 61 connected to the rotating shaft 51a of the electric motor 5 (FIG. 2). The tooth number of the ring gear 62 of the second planetary gear mechanism 6 is twice the tooth number of the sun gear 61 of the second planetary gear mechanism 6. Thus, rotational speeds of the left and right rotating shafts (sun gear 61 and carrier 65) of the second planetary gear mechanism 6 can be made equal to each other, and the rotation directions thereof can be made opposite to each other. As a result, favorable turn characteristics can be obtained without making a difference between the left and right turn characteristics.

Although, in the above embodiment, the first gear 14 is disposed above the electric motor 1, the first gear may be disposed below the electric motor. In this case, the pair of left and right second gears are disposed on the lower ends of the second rotating shafts 21 so as to be engaged with the first gear. Although, in the above embodiment, the pair of left and right second rotating shafts 21 are disposed in oblique rear positions with respect to the first rotating shaft 13, the second rotating shafts may be disposed in oblique front positions with respect to the first rotating shaft. Accordingly, the worm wheels 31 also may not be disposed as described above.

Although, in the above embodiment, the electric motor 5, second planetary gear mechanism 6, controller 8, and the like form the speed difference absorbing unit 101, a speed difference absorbing unit may be configured otherwise as long as it absorbs the speed difference between the pair of left and right drive shafts during a turn of the vehicle.

Although, in the above embodiment, the second planetary gear mechanism 6 is disposed on the right side of the electric motor 5, the second planetary gear mechanism may be disposed on the left side of the electric motor. The sun gear 61 and carrier 65 of the second planetary gear mechanism 6 may be disposed in a left-right inverted manner. Although, in the above embodiment, the sun gear 41 of the first planetary gear mechanism 4 is connected to the rotating shaft 51a of the electric motor 5, a reduction gear may be connected to the electric motor and the sun gear may be connected to the reduction gear. A clutch that is engaged during a turn travel and is disengaged during a straight travel may be disposed on the sun gear 61 or carrier 65 of the second planetary gear mechanism 6. Thus, heating of the electric motor 5 during a straight travel can be reduced.

The above embodiment can be combined as desired with one or more of the above modifications. The modifications can also be combined with one another.

According to the present invention, a vehicle drive apparatus for driving a vehicle by a power of an electric motor can be easily disposed in a predetermined height-limited space in the vehicle.

Above, while the present invention has been described with reference to the preferred embodiments thereof, it will be understood, by those skilled in the art, that various changes and modifications may be made thereto without departing from the scope of the appended claims.

What is claimed is:

1. A vehicle drive apparatus, comprising:
an electric motor including a rotor rotating about a first axial line in a vertical direction and a stator disposed around the rotor;
a first rotating shaft extended along the first axial line to rotate integrally with the rotor and including a first gear at an end portion thereof;
a pair of left and right second rotating shafts extended along a pair of left and right second axial lines parallel to the first axial line in a state separate from each other in a left-right direction, and including second gears at end portions thereof so as to mesh with the first gear respectively and worm gears rotating about the pair of left and right second axial lines;
a pair of left and right worm wheels rotatable about a third axial line in the left-right direction and provided so as to mesh with the worm gears, respectively; and
a pair of left and right drive shafts to which torques from the pair of left and right worm wheels are input, respectively.

2. The apparatus according to claim 1, further comprising:
a pair of left and right planetary gear mechanisms installed inside the pair of left and right worm wheels, respectively, so as to transmit the torques from the pair of left and right worm wheels to the pair of left and right drive shafts; and
a speed difference absorbing unit configured to absorb a speed difference between the pair of left and right drive shafts during a turn travel of a vehicle.

3. The apparatus according to claim 2, wherein
the electric motor is a first electric motor,
the pair of left and right planetary gear mechanisms are a pair of first planetary gear mechanisms of a single pinion type, including a pair of left and right ring gears connected to the pair of left and right worm wheels respectively, a pair of left and right carriers connected to the pair of left and right drive shafts respectively, and a pair of left and right sun gears, and
the speed difference absorbing unit includes a second electric motor and a second planetary gear mechanism of a double pinion type serially interposed between the pair of left and right sun gears, and a control unit configured to control the second electric motor.

4. The apparatus according to claim 3, wherein
the second planetary gear mechanism includes a ring gear provided in an non-rotatable manner, a carrier connected to one of the pair of left and right sun gears, and a sun gear connected to a rotating shaft of the second electric motor, and
a tooth number of the ring gear of the second planetary gear mechanism is twice a tooth number of the sun gear of the second planetary gear mechanism.

5. The apparatus according to claim 3, further comprising:
a vehicle speed detector configured to detect a vehicle speed; and
a steering angle detector configured to detect a steering angle, wherein
the control unit is configured to calculate a target speed difference between the pair of left and right drive shafts based on signals from the vehicle speed detector and the steering angle detector, calculate a target rotational speed of the second electric motor corresponding to the target speed difference, and control a rotational speed of the second electric motor to the target rotational speed.

6. The apparatus according to claim 1, wherein
the pair of left and right worm wheels are disposed below the second gears of the pair of left and right second rotating shafts, respectively.

7. The apparatus according to claim 1, wherein
the first gear and the second gears are formed in spur gears of helical gears.
